(19) United States
(12) Patent Application Publication
(10) Pub. No.: US 2013/0278010 A1
(43) Pub. Date: Oct. 24, 2013

(54) SECURING OF A PANE OF GLASS PROVIDED WITH AN INSERT-MOULDED EDGE SECTION, IN PARTICULAR A PANE OF GLASS FOR AN AUTOMOBILE

(71) Applicant: Bernhard Kreye, Wunstorf (DE)

(72) Inventor: Bernhard Kreye, Wunstorf (DE)

(73) Assignee: HENNIGES AUTOMOTIVE GMBH & CO. KG, Rehburg-Loccum (DE)

(21) Appl. No.: 13/996,029

(22) PCT Filed: Nov. 25, 2011
(86) PCT No.: PCT/DE11/02039

§ 371 Date: Jul. 2, 2013

(30) Foreign Application Priority Data
Dec. 21, 2010 (DE) 20 2010 016 886.4

(51) Int. Cl. B60J 1/00

(52) U.S. Cl. CPC B60J 1/006
USPC 296/146.15

(57) ABSTRACT

The invention relates to the securing of a pane of glass which is provided with an insert-molded edge section (6), in particular a pane of glass for an automobile, in a window opening which is provided for that purpose and which is preferably a window opening in the bodywork of an automobile. To that end, the insert-molded edge section (6) has catch protrusions (1) which are formed together during production of the section, and which can each be snap-connected respectively to catch holes (8) which are arranged in the edge region of the window opening and in particular in the automobile bodywork panel. In this way the pane of glass for an automobile, provided with an insert-molded edge profile, can be secured in a window opening in automobile bodywork more easily and thus more rapidly.

The invention pertains to the securing of a pane of glass that is provided with an insert-moulded edge section, particularly a pane of glass for an automobile, in a window opening provided for that purpose, preferably a window opening in the bodywork of an automobile.

Automotive panes of glass that are provided with edge or border sections have the advantage that they can be supplied to the installation site in the automobile factory in a prepared state, in which they are ready to be installed. The securing in the window opening of the automobile bodywork is realized with suitable adhesives that can also be applied in a mechanized fashion, for example, with the aid of robots in order to simplify the installation. The prepared pane of glass then merely needs to be aligned and pressed into the applied adhesive bed.

The alignment, of the pane is particularly important with respect to ensuring its correct seat in the window opening. The actual alignment cannot take up too much time because the adhesive would otherwise already begin to set. However, the handling of implements that ensure a flawless alignment requires a corresponding expenditure of time, particularly if it needs to be carried out and controlled by workers.

It is the objective of the invention to simplify and thusly accelerate the securing of an automotive pane of glass that is provided with an insert-moulded edge section in a window opening in the bodywork of an automobile.

According to the invention, this objective is attained with the characteristics of Claim 1. Enhancements and advantageous embodiments of the invention are defined in Claims 2 to 9.

Due to the fact that the insert-moulded edge section features catch protrusions that are formed during its production and can be respectively snap-connected to catch holes arranged in the edge region of the window opening, particularly catch holes arranged in the automobile bodywork panel, the automotive pane of glass is aligned and fixed in its assigned window opening of the automobile bodywork as soon as the catch protrusions on the insert-moulded edge section of the pane of glass are snapped into the catch holes. This is realized by simply pressing the pane of glass against the automobile bodywork with its edge section such that the catch protrusions snap into the catch holes. In this way, the entire pane of glass is fixed in the window opening along its border in the intended position. The process of pressing the pane of glass against the automobile bodywork until the catch protrusions snap into the catch holes only requires little installation time.

As soon as the pane of glass comes in contact with the adhesive applied in the region of the window opening, for example, onto a flange of the automobile bodywork, the curing of the adhesive begins such that the thusly positioned pane of glass is ultimately fixed in the automobile bodywork as soon as the adhesive cures.

Each catch protrusion preferably has the shape of a cuboid that protrudes from the respective surface of the edge section. In this case, each catch hole is realized in the form of an approximately rectangular oblong hole. This rectangular shape simplifies the precise alignment of the pane of glass to be positioned in the window opening of the automobile bodywork. In addition, this shape of the catch protrusions and the corresponding catch holes provides the advantage that the number of catch holes in the bodywork and the number of catch protrusions on the pane of glass can be reduced to a minimum. It is particularly advantageous to secure the pane of glass with only three catch profiles and three corresponding catch holes, wherein a three-point bearing that provides static advantages with respect to the support of the pane of glass in a plane is formed in this case.

The pane of glass is optimally seated in the window opening as soon as the cuboid catch profiles are snap-connected to the catch holes realized in the form of rectangular oblong holes because each catch protrusion has the shape of a cuboid and protrudes from the respective surface of the edge section and because each catch hole is realized in the form of an approximately rectangular oblong hole, wherein the longitudinal axis of each catch protrusion and of each catch hole is aligned parallel to the outer edge of the pane of glass with the insert-moulded edge section.

This snap connection can be produced due to the fact that the free end of each catch protrusion features snap-in tabs that overlap the opening edge of the respective catch hole in the bodywork panel. If the catch protrusion is pressed into the catch hole with a corresponding expenditure of force, the snap-in tabs are deformed and then reliably snap into the catch holes.

The deformation of the catch protrusion, by means of which the above-described snap connection can be produced, is simplified in that each catch protrusion features in the region of its free end a hollow chamber that extends parallel to its longitudinal axis. Outer longitudinal walls defining the hollow chamber feature snap-in beads that form the snap-in tabs and are integrally moulded onto the outer longitudinal walls in the region of their upper free edge, wherein said snap-in beads can elastically deform the respective outer longitudinal wall of the hollow chamber when the catch protrusion is pressed into a catch hole. Due to their elasticity, the snap-in tabs snap back into their original position such that the catch protrusions are snap-connected to the catch holes.

This advantageous snap connection can be produced, in particular, due to the fact that the material for the edge section with its catch protrusions consists of an elastomer. The elastomer preferably has a Shore hardness of 50 to 90 Shore A.

An exemplary embodiment that features other inventive characteristics is illustrated in the drawings. In these drawings:

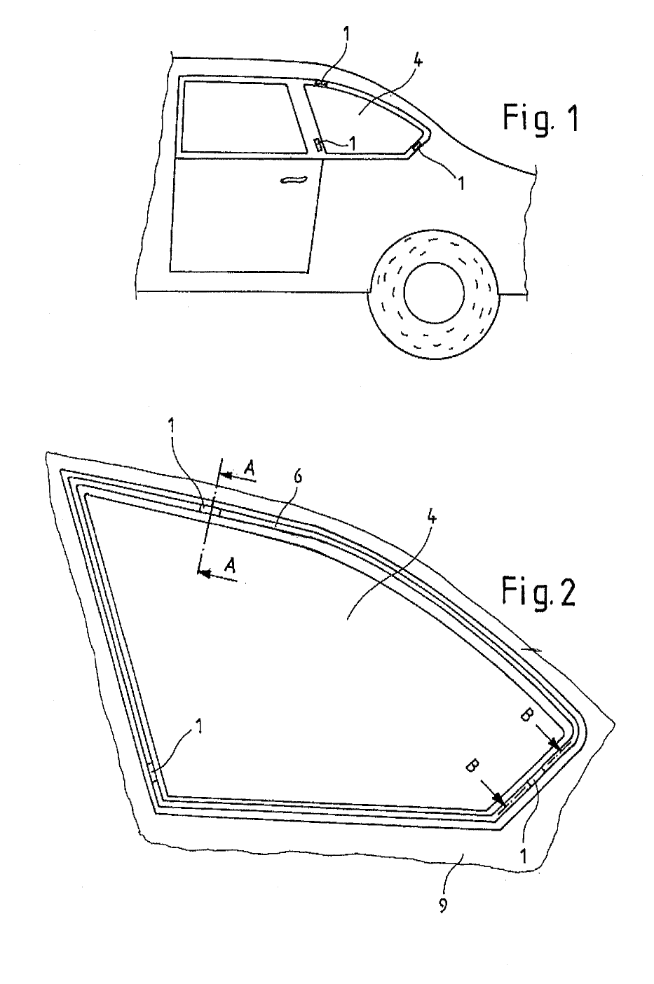

FIG. 1 shows a side view of the rear region of an automobile, wherein a pane of glass provided with an edge section is positioned in a window opening of the automobile bodywork that forms a rear side window;

FIG. 2 shows a side view of the rear side window according to FIG. 1;

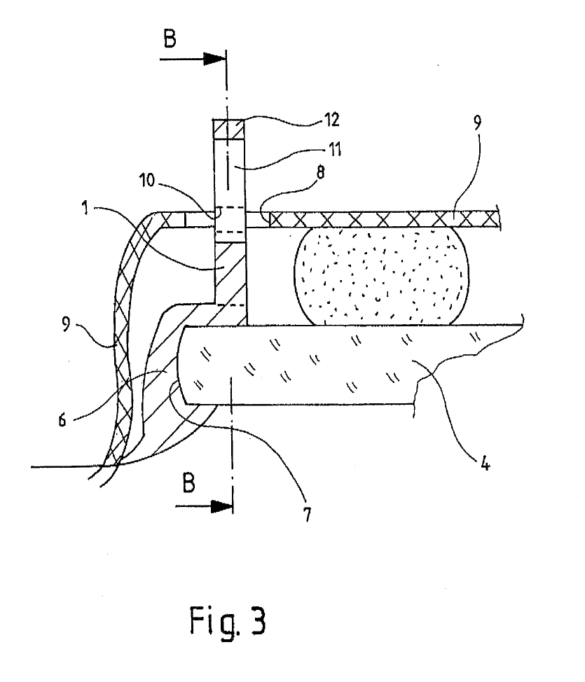

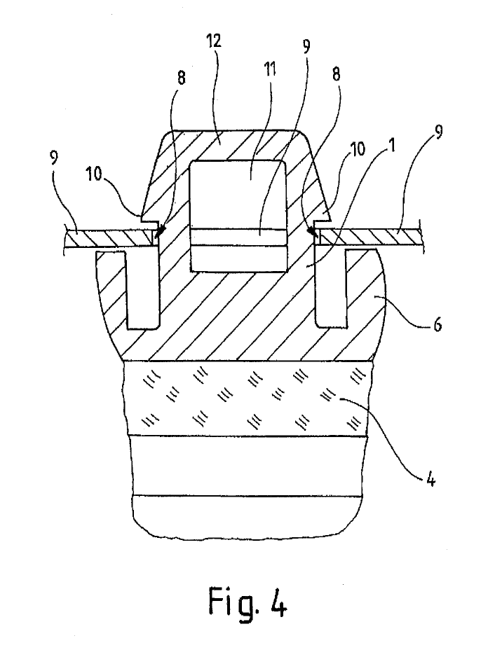

FIG. 3 shows a section along the line A-A in FIG. 2, and

FIG. 4 shows a section along the line B-B in FIG. 2 and in FIG. 3.

FIG. 1 shows a schematic side view of the rear region of the bodywork of an automobile that features a window opening, in which an automotive pane of glass 4 is positioned. The automotive pane of glass is provided with an insert-moulded edge section 6 of an elastomer that features integral catch protrusions 1 formed together with the insert-moulded edge section at predefined locations.

FIG. 2 shows the pane of glass 4 with the insert-moulded edge section 6 that features catch protrusions 1 formed together with the edge section in the form of a side view.

FIG. 3 shows a section along the line A-A in FIG. 2. Identical components are identified by the same reference symbols. The moulding of the edge section 6 around the outer edge 7 of the pane of glass 4 is elucidated in FIG. 3, particularly in connection with FIG. 4. The rectangular and therefore cuboid-shaped catch protrusion 1 features on its free end snap-in tabs 10 that overlap the opening edge of the respective catch hole 8 in the panel 9 of the bodywork. In the region of its free end, each catch protrusion 1 features a hollow chamber 11 that extends parallel to its longitudinal axis such that a reinforcing web 12 is formed in the upper region. The web hampers a separation of the secured pane of glass. An indicated adhesive application for producing a connection between the pane of glass 4 and the bodywork panel 9 is identified by the reference symbol 13.

Outer longitudinal walls defining the hollow chamber feature the snap-in beads that form the snap-in tabs and are integrally moulded onto the outer longitudinal walls in the region of their upper free edge.

The material for the edge section 6 with the catch protrusions 1 consists of an elastomer that has a Shore hardness of 50 to 90 Shore A.

FIG. 4 shows a section along the line B-B in FIG. 2 and in FIG. 3, wherein identical components are once again identified by the same reference symbols.

1. The securing of a pane of glass that is provided with an insert-molded edge section, particularly a pane of glass for an automobile, in a window opening provided for that purpose, preferably a window opening in the bodywork of an automobile,
wherein the insert-molded edge section (6) features catch protrusions (1) that are formed during its production and can be respectively snap-connected to catch holes (8) arranged in the edge region of the window opening, particularly catch holes (8) arranged in the panel (9) of the automobile bodywork.

2. The securing according to claim 1, wherein each catch protrusion (1) has the shape of a cuboid and protrudes from the respective surface of the edge section (6), and wherein each catch hole (8) is realized in the form of an approximately rectangular oblong hole.

3. The securing according to claim 2, wherein the longitudinal axis of each catch protrusion (1) and of each catch hole (8) is aligned parallel to the outer edge of the pane of glass (4) with the insert-moulded edge section (6).

4. The securing according to claim 3, wherein the free end of each catch protrusion (1) features snap-in tabs (10) that overlap the opening edge of the respective catch hole (8) in the panel (9) of the bodywork.

5. The securing according to claim 1, wherein each catch protrusion (1) features in the region of its free end a hollow chamber (11) that extends parallel to its longitudinal axis.

6. The securing according to claim 5, wherein outer longitudinal walls defining the hollow chamber (11) feature snap-in beads that form the snap-in tabs (10) and are integrally molded onto the outer longitudinal walls in the region of their upper free edge.

7. The securing according to claim 1, wherein the material for the edge section (6) with the catch protrusions (1) consists of an elastomer.

8. The securing according to claim 7, wherein the elastomer has a Shore hardness of 50 to 90 Shore A.

9. The securing according to claim 1, wherein each catch protrusion (1) features a shaft that rises from the surface of the edge section (6) and snap-in beads that are integrally molded onto the free end of the shaft and form snap-in tabs (10).
